(19) United States
(12) Patent Application Publication
(10) Pub. No.: US 2025/0122916 A1
(43) Pub. Date: Apr. 17, 2025

(54) ELECTROMECHANICAL FRAME BRAKE

(71) Applicant: ZF Active Safety GmbH, Koblenz (DE)

(72) Inventors: Lukas Madzgalla, Lahnstein (DE); Florian Roessinger, Neuwied (DE); Marco Becker, Oberduerenbach (DE); Guido Zenzen, Macken (DE)

(21) Appl. No.: 18/911,779

(22) Filed: Oct. 10, 2024

(30) Foreign Application Priority Data
Oct. 13, 2023 (DE) 102023127980.7

(51) Int. Cl. F16D 65/18; F16D 55/00; F16D 121/24; F16D 125/40

(52) U.S. Cl. CPC F16D 65/18; F16D 2055/002; F16D 2055/0041; F16D 2121/24; F16D 2125/40

(57) ABSTRACT

An electromechanical frame brake is disclosed. The electromechanical frame brake comprises a floating frame assembled from a plurality of parts, and a brake piston, which can be moved axially by a spindle drive and is seated on a spindle of the spindle drive and guided in a piston-receiving housing. The floating frame has the piston-receiving housing, lateral struts, and an outer crossmember, which is connected via the struts to the piston-receiving housing. The crossmember carries an outer brake pad. The floating frame is mounted by way of axial linear guides in a brake carrier of the frame brake in such a way as to float and to be axially movable relative to the brake carrier. The brake carrier has a socket with a guide surface for the piston-receiving housing, which is mounted in an axially movable manner in said socket.

### CROSS-REFERENCE TO RELATED APPLICATIONS

This application claims priority to DE Patent Application No. 102023127980.7 filed on Oct. 13, 2023, the disclosure of which is incorporated herein by reference in its entirety.

### TECHNICAL FIELD

The present disclosure relates to an electromechanical frame brake.

### BACKGROUND

Electromechanical brakes having a floating frame have long been known.

The floating frame can be designed as a fist-type caliper, for example. Owing to the geometry of the caliper shape, however, fist-type caliper brakes have a limited torsional rigidity. Shear forces caused by the frictional forces that arise when the brake pads are applied to a brake disc rotor and cause twisting of components of the brake relative to the brake carrier are therefore only inadequately compensated. As a consequence, the brake pads exhibit non-uniform degrees of wear. This leads to a varying ratio of occurring shear forces to occurring normal forces (along the axial direction) over the life of the brake pads and of the brake disc rotor. The inconstancy of this force ratio prevents or at least disadvantageously affects the provision of constant release clearances (distances between the brake pads and the brake disc rotor, also referred to as the brake application path) over the life of the brake pads and of the brake disc rotor.

As an alternative to fist-type caliper brakes, electromechanical brakes can also be embodied as frame brakes. Frame brakes comprise axially formed linear guides, which can at least partially absorb and compensate the occurring shear forces. As a result, force ratios of the occurring shear forces to the occurring normal forces that exhibit reduced fluctuations over the life of the brake pads and of the brake disc rotor as compared with fist-type caliper brakes can be ensured. However, the axial linear guides are typically not arranged at the centre of gravity along the axial extent of the frame brake. This leads to tilting forces along the axial extent of the frame brake and, although these may be smaller than the comparable shear forces in the case of fist-type caliper brakes, they nevertheless cause twisting of components of the frame brake relative to a brake carrier. In other words, frame brakes have a limited housing rigidity along the axial longitudinal extent as a result, among other factors, of the generally higher weight due to the linear guides. Thus, in turn, non-uniform degrees of wear of the brake pads and thus inconstant brake application paths may be caused over the life of the brake pads and of the brake disc rotor. Of course, the housing rigidity along the axial longitudinal extent of the frame brake can be increased by appropriate dimensioning of the relevant components. However, this brings about an increase in the required installation space and in the weight of the frame brake, ultimately causing increased fuel or energy consumption by a vehicle fitted with such a frame brake.

There is therefore a need to eliminate or at least reduce the disadvantages of the prior art. In particular, there is a need to provide an electromechanical brake which ensures a constant brake application path over the life of the relevant components while simultaneously reducing weight and installation space in comparison with existing approaches.

### SUMMARY

The disclosure is directed to the subject matter of the independent patent claims. Advantageous exemplary arrangements are specified in the dependent patent claims and the following description, each of which can represent aspects of the disclosure individually or in (sub) combination. Some aspects are explained with respect to different variants. However, the features are interchangeable.

According to one exemplary aspect, an electromechanical frame brake is provided. The electromechanical frame brake comprises a floating frame assembled from a plurality of parts, and a brake piston, which can be moved axially by a spindle drive and is seated on a spindle of the spindle drive and is guided in a piston-receiving housing. The floating frame has a piston-receiving housing, lateral struts, and an outer crossmember, which is connected via the struts to the piston-receiving housing. The crossmember carries an outer brake pad. The floating frame is mounted by way of axial linear guides in such a way as to float relative to a brake carrier of the frame brake and to be axially movable relative to the brake carrier. The brake carrier has a socket with a guide surface for the piston-receiving housing, which is mounted in an axially movable manner in said socket.

This provides a frame brake which, in addition to the lateral struts and axial linear guides, includes additional guidance by the socket of the brake carrier, which has a guide surface for the piston-receiving housing mounted movably therein. Thus, an additional axial guide mechanism, by which the occurring shear forces during the activation of the frame brake can be compensated in an improved way in comparison with existing approaches, is ensured. In addition, the socket of the brake carrier for the piston-receiving housing mounted movably therein can, for example, be arranged closer to the centre of gravity along the axial longitudinal extent of the frame brake. As a consequence, the occurring tilting forces that are caused by the weight distribution of the frame brake along the axial longitudinal extent can be reduced in comparison with existing approaches. This provides a frame brake which has improved housing rigidity, both in respect of the occurring shear forces and in respect of the weight distribution along the axial longitudinal extent. This ensures that the force ratio of the occurring shear forces to the occurring normal forces during the activation of the frame brake is substantially constant over the life of the brake pads and of the brake disc rotor. As a consequence, the constancy of the actual brake application path (that is to say the distance between the brake pads and the brake disc rotor) over the life of the brake pads and of the brake disc rotor is improved over existing approaches. In other words, the non-uniform degrees of wear of the brake pads can be reduced. Thus, the actual brake application path also exhibits reduced deviations from the desired brake application path over the life of the brake pads and of the brake disc rotor in comparison with existing frame brakes. These advantages are ensured without the need to use excessive material or to (significantly) enlarge the installation space for this purpose. A solution which does not cause any increase in the underlying fuel or energy consumption of a vehicle fitted with such an electromechanical frame brake is therefore provided.

The brake carrier may form a component that can be fixed on the vehicle and by which the electromechanical frame brake can be mounted on a mount, e.g. a vehicle support structure.

In one exemplary arrangement, the guide surface is of cylindrical design. This ensures a symmetrical construction in relation to the radial extent, thereby making possible efficient absorption of transverse forces perpendicular to the longitudinal direction of extent of the frame brake.

In some exemplary arrangement, at least in some region or regions, the guide surface is formed concentrically with a piston lateral surface of the brake piston. This makes it possible to prevent the occurrence of eccentrically acting forces during activation of the brake piston. In other words, the alignment of the occurring forces is improved. The occurrence of shear forces relative to the longitudinal extent or of tilting forces along the axial longitudinal extent of the frame brake is reduced or even prevented.

As an option, the axial linear guides are sliding bearings on the brake carrier. It is thereby possible to ensure mobility along the axial direction of extent of the frame brake with low frictional forces.

The sliding bearings may be arranged at equal radial distances from a centre of the cylindrical guide surface. Uniform force distribution to the sliding bearings, measured at the centre of the cylindrical guide surface, is thereby ensured. In other words, although two mutually spaced guide mechanisms are provided by the sliding bearings and the cylindrical guide surface, these act as a quasi-unitary guide mechanism. The arrangement is chosen so that no eccentric forces are caused by the relative arrangement itself. As a consequence, the housing rigidity of the frame brake is further improved.

In some exemplary arrangements, the floating frame surrounds the brake carrier in a top view of the frame brake. Since the brake carrier ensures coupling to a vehicle structure, it represents the force application point in respect of the frame brake weight to be borne. The geometry specified here ensures that the floating frame, which represents the axial support structure, surrounds the brake carrier as a force application point. It is thereby possible to further improve housing rigidity.

As an option, the struts merge integrally into the crossmember. It is thereby possible to reduce both the number of components required and the number of material transitions and coupling points. This measure too leads to an improvement (increase) in housing rigidity.

The piston-receiving housing may be screwed to the struts at the end face. In this way, a releasable connecting mechanism is created between the piston-receiving housing and the crossmember, thereby simplifying assembly or servicing work, for example.

As an option, the brake carrier has a window which is open radially towards the outside and through which an inner brake pad can be installed and removed without removing the floating frame.

Alternatively or cumulatively, a window which is open radially towards the outside and through which the outer brake pad can be installed and removed without removing the floating frame is provided between the brake carrier and the crossmember.

The window that is open radially towards the outside simplifies servicing work for the replacement of the brake pads since it does not require the removal of the floating frame. In addition, the air flow cross section for the ventilation of the brake pads can be increased by the windows. This improves the cooling of the brake pads.

As an option, the piston-receiving housing has a base, on which the spindle is supported during the actuation of the frame brake. It is thereby possible to absorb the reaction forces which occur on account of the application forces during the activation of the brake. Starting from the base of the piston-receiving housing, the reaction forces absorbed can then be transmitted further for example to the crossmember, in order to bring the outer brake pad into contact with the brake disc rotor.

In some exemplary arrangements, the piston-receiving housing has a plurality of axially extending side walls of cylindrical design, by which axial guides can be provided for the spindle and/or the brake piston.

The side walls and the base delimit a free internal volume enclosed by the piston-receiving housing, said volume defining an interior space of the piston-receiving housing. The brake piston is at least partially accommodated in the interior space of the piston-receiving housing.

In one exemplary arrangement, an axial spindle bearing having a bearing contact surface is arranged between the base of the piston-receiving housing and the spindle. The axial spindle bearing provides the possibility of simultaneously supporting the spindle and, in addition, enabling rotation of the spindle relative to the base of the piston-receiving housing. In addition, the spindle bearing can be used to compensate for the occurrence of eccentrically acting forces.

In some exemplary arrangements, the spindle merges at its drive-side end, via an encircling shoulder, into a drive shaft extension of reduced cross section. The shoulder has a convex section which forms a ring on a spherical surface. The axial spindle bearing has a complementary contact section with the bearing contact surface to allow a tilting movement of the spindle relative to the piston-receiving housing. For example, the contact section of the axial spindle bearing is complementary to the convex spindle shoulder section that forms a ring on a spherical surface. The complementarity of the contact section of the axial spindle bearing and of the spindle shoulder section that forms the spherical surface provides a centring mechanism by which even off-centre force components of the reaction force are compensated.

In other words, the radial extent of the spindle varies along the axial direction, to be precise in such a way that the spindle has a comparatively small radial extent at the end opposite the brake pad, and a comparatively large radial extent at the brake-pad end. Since the transitional section of the spindle is arranged between these sections and forms a taper of the spindle with respect to the radial extent, the outer surface of the transitional section can advantageously have the encircling shoulder. This forms the convex section that forms a ring on a spherical surface and is in contact with the axial spindle bearing.

The axial spindle bearing and the spindle section that forms the spherical surface can be rotationally symmetrical. As a result, the axial spindle bearing and the spindle section can be formed identically on all sides with respect to the rotation axis of the spindle.

In one exemplary arrangement, the bearing contact surface of the axial spindle bearing is spherically shaped.

A spherical bearing contact surface is to be understood, for example, as meaning a bearing surface which has a spherical contour.

The spherical bearing contact surface may be concavely shaped.

A restoring force in the direction of the rotation axis of the spindle is then brought about by the curvature of the spherical bearing contact surface. Here, the spherical contour ensures that the restoring force increases with increasing distance of the force application point from the axis of rotation of the spindle. This means that, when the force application point is suitably selected, greater restoring forces are brought about, which force the spindle into an orientation along the rotation axis.

As an option, the spherical bearing contact surface of the axial spindle bearing has a first radius of curvature and the complementary contact surface of the transitional section has a second radius of curvature. Advantageously, the first radius of curvature and the second radius of curvature are different. This leads to line contact (circular line) between the complementary contact surface and the bearing contact surface, for example in the case where no force is applied. When the application force is generated and the reaction forces therefore occur, starting from the line contact, surface contact is formed between the contact surfaces as the force increases owing to elastic flattening of the surfaces. The contact surfaces are thus in close contact. In this way, it is possible to ensure that the centring effect is more pronounced as the force increases.

In one exemplary arrangement, the axial spindle bearing can be an axial rolling bearing. The axial spindle bearing ensures the rotatability of the spindle relative to the piston-receiving housing without an increased frictional torque occurring in the process.

In one exemplary arrangement, on the opposite side from the spherical bearing contact surface, the axial spindle bearing can have a planar contact surface on a bearing ring, by which it is supported axially on the adjacent rolling elements. As a result, the axial spindle bearing, with the spherical bearing contact surface and the opposite, planar contact surface, ensures as uniform as possible contact between the rolling elements and the bearing ring because the degrees of freedom of rotation transversely to the rotation axis of the spindle are not removed and thus microscopic and macroscopic angular displacements or off-centre force effects can be compensated.

In one exemplary arrangement, the axial spindle bearing is supported on the base of the piston-receiving housing. The piston-receiving housing is oriented in such a way that the open end is arranged in the direction of the brake disc rotor and of the inner brake pad, that is to say on the brake pad side, and that the base of the piston-receiving housing is arranged opposite thereto in the axial direction. This means that the generated application forces act in the axial direction along the open end of the piston-receiving housing while the reaction forces occurring as a result act in the direction of the base. Because the axial spindle bearing is supported on the base of the piston-receiving housing, the axial spindle bearing is thus arranged between the base and the spindle along the direction of action of the reaction forces. This enables the axial spindle bearing to absorb the reaction forces in a particularly effective manner.

In one exemplary arrangement, the base of the piston-receiving housing has a high plateau, which extends axially from the base in the direction of the brake disc rotor. This enables the axial spindle bearing to be positioned further into the interior of the brake piston. In this way, the axial length of the piston-receiving housing of the frame brake can be shortened, and the installation space required in the axial direction can be reduced.

A bearing disc is arranged axially between the base of the piston-receiving housing and the rolling elements of the axial spindle bearing, which bearing disc is pressed into the piston-receiving housing in a manner such that it is secured against rotation by frictional engagement and/or positive engagement. Owing to its geometry, the piston-receiving housing represents a more complex component than the bearing disc. Due to the bearing disc, the base of the piston-receiving housing can be protected from damage due to the axial spindle bearing (if the latter were in direct contact with the base) that might in general be caused in the case of a worn axial spindle bearing and under the action of the reaction forces. Thus, in case of necessity, it is only the bearing disc or the entire axial spindle bearing that has to be exchanged but not necessarily the piston-receiving housing.

For example, the bearing disc can have two opposite planar contact surfaces, one of which is in contact with the base of the piston-receiving housing and one is in contact with the rolling elements. The additional advantage is obtained that the production effort required to ensure the quality of the contact surface of the base of the piston-receiving housing can be reduced.

The rolling elements of the axial spindle bearing then roll, on the one hand, on the planar contact surface of the bearing ring on the brake-pad end of the axial spindle bearing and, on the other hand, on a planar contact surface of the bearing disc, which likewise forms a bearing ring.

A bearing arrangement is provided between the drive shaft extension of reduced cross section of the spindle and the piston-receiving housing, e.g. by a ball bearing or sliding bearing. An axial mobility of the spindle relative to the piston-receiving housing is prevented by a fastening arrangement, such as, e.g. a snap ring. The snap ring can be arranged in a radial groove of the piston-receiving housing, for example, more specifically starting from the base of the piston-receiving housing, opposite to the brake disc rotor. The snap ring can also be multilayered.

In one exemplary arrangement, the brake piston is shaped as a spindle nut by the formation of a spindle thread on its inner side. The spindle drive is configured to ensure linear mobility of the brake piston relative to the spindle. Due to the spindle drive, the brake piston acting as a spindle nut can be moved in the axial direction. In this way, the brake piston can subject at least one brake pad (the inner brake pad) of the brake to an application force, thus enabling frictional engagement with the brake disc rotor to be generated. This means that the spindle can be rotated about the rotation axis, and that this rotation causes a translational movement of the brake piston along the axial direction in order to provide application forces for at least one brake pad (the inner brake pad). Owing to the application forces generated, oppositely oriented reaction forces occur, which generally have off-centre force components. In general, these force components can cause shear forces, but these can be absorbed and compensated by the plurality of guide mechanisms, that is to say the lateral struts, the axial linear guides and the socket with the cylindrical guide surface.

In the case of the electromechanical frame brake explained here, a rotary lock is provided between the piston-receiving housing and the brake piston mounted in a linearly movable manner therein. The rotary lock permits a linear movement of the brake piston but prevents rotation of the brake piston relative to the piston-receiving housing.

In one exemplary arrangement, the rotary lock comprises a slotted hole with which a rotational securing element is in engagement.

As an option, a rotational securing arrangement is provided between the piston-receiving housing and the brake carrier of the frame brake. For example, a positive connection can be provided between the piston-receiving housing and the brake carrier, which prevents rotation of the piston-receiving housing with respect to the brake carrier.

The positive connection provided for securing the piston-receiving housing against rotation can have a slot-and-key connection, a tangential-pin connection or a slotted hole with which a rotational securing element is in engagement.

As an option, an axially extending seal is provided radially between the brake piston and the brake carrier. It is thereby possible to protect the inner guide surfaces of the brake carrier and of the piston-receiving housing for the brake piston from contaminants (e.g. abraded brake material). In this way, the life of the spindle drive and of the socket for the piston-receiving housing mounted in an axially movable manner can be extended.

An encircling bellows seal is arranged radially on the outside between the brake carrier and the piston-receiving housing. The bellows seal makes it possible to prevent contaminants from being able to enter the socket for the axially movably mounted piston-receiving housing from the outside. The life of the guide mechanism of the socket is thus extended.

In some exemplary arrangements, the brake carrier has a return element. The socket of the brake carrier has such a return element. The return element is configured to return the piston-receiving housing to an initial position, for example along the axial longitudinal extent of the frame brake, in a state of the frame brake in which it is not subject to any force. When the application force is exerted, the piston-receiving housing is moved along the axial direction by the reaction forces that occur, more specifically along the opposite direction to the brake disc rotor. In other words, the distance between the piston-receiving housing and the brake disc rotor increases. As a result, the outer brake pad comes into contact with the brake disc rotor. When the imposition of the application force is ended, reaction forces no longer occur either. In this case, the return element ensures that the piston-receiving housing and hence also the crossmember coupled to the piston-receiving housing, and the outer brake pad are moved back into the initial position (position in which no force is applied), i.e. in the direction of the brake disc rotor. This ensures that the outer brake pad is freed with respect to the brake disc rotor.

The socket of the brake carrier has a groove in which the return element is arranged. Due to the groove it is possible to save installation space along the axial extent of the frame brake. In addition, this arrangement also enables the return element to act as an additional sealing element, making it possible to avoid the entry of contaminants.

As an option, the return element has an annular body. The return element is arranged radially on the outside of a housing lateral surface of the piston-receiving housing. Circular symmetry in respect of the restoring force produced by the return element is thereby ensured. The alignment of the frame brake is additionally improved.

In one exemplary arrangement, the return element comprises an elastic material, for example an elastomer. The return element can then adapt particularly well to the installation space available between the brake carrier and the piston-receiving housing. In addition, the durability of the return element is increased. The return element may be deformed when a force is applied to the frame brake, i.e. when the frame brake is actuated, and stores deformation energy during this process. Here, the return element is operatively connected to the brake carrier and the piston-receiving housing in such a way that, when the brake is released, i.e. when the force applied to the frame brake is removed, the stored deformation energy is released and the piston-receiving housing and thus also the crossmember coupled to the piston-receiving housing, and the outer brake pad are moved back into the initial position as already described.

Alternatively, it is also possible for the return element to be designed as a metal spring, for example as an encircling metal spring.

In some exemplary arrangements, the bellows seal may also be omitted. The return element can then additionally ensure the sealing functionality of the bellows seal. As a result, the frame brake advantageously has fewer components. Moreover, production is less complex.

As an option, the brake piston has an end wall on the brake-pad side, said wall pressing against an inner brake pad of the frame brake when the brake is applied. The end wall can have an end face in the form of a circular ring. As a result, the force application point of the application force acting on the brake pad is shifted radially outwards, allowing more uniform loading of the brake pad in terms of the area. That is to say that the application of force to the brake pad is improved.

In one exemplary arrangement, the spindle drive has a recirculating ball screw. In the case of a recirculating ball screw, balls transmit the force between the spindle and the brake piston acting as a spindle nut. Owing to the rolling movement of the balls, friction and wear are reduced. A recirculating ball screw is free from self-locking. This means that, on account of elasticities inherent in the system, the brake piston also moves back automatically into the retracted position when it is no longer actively being loaded into the extended position by operation of a motor, for example an electric motor.

A rotation of the spindle is provided by an electric motor and of a reduction gear assembly of the frame brake, which meshes with the drive shaft extension of the spindle.

As an option, the piston-receiving housing in which the spindle is mounted has a positive movable connection to the gear assembly used to drive the spindle. This ensures centring of the gear assembly of the drive relative to the piston-receiving housing.

The positive connection between the piston-receiving housing and the gear assembly of the drive has a shaft-hub connection with spline toothing or a slot-and-key connection.

For example, the electromechanical frame brake can be configured to serve as a vehicle brake comprising brake pads and a brake disc rotor.

According to a further aspect, a vehicle having an electromechanical frame brake as described above is also provided.

As an option, the vehicle can comprise, for example, a motor vehicle, that is to say a road vehicle. Alternatively, the vehicle can also comprise other types of vehicle, for example two-wheelers, motorcycles, or the like. Overall, a vehicle is to be understood in the present case to mean a device which is configured for transporting objects, freight or persons between different destinations. Examples of vehicles are land-based vehicles such as motor vehicles, electric vehicles, hybrid vehicles or the like. In the present context, vehicles can be regarded as road vehicles, such as cars, trucks, buses or the like.

All features explained in respect of the various aspects can be combined individually or in (sub) combination with other aspects.

### BRIEF DESCRIPTION OF THE DRAWINGS

The disclosure and further advantageous exemplary arrangements and developments thereof are described and explained in greater detail below with reference to the examples illustrated in the drawings. In the drawings:

FIG. 1 shows a simplified schematic isometric illustration of an electromechanical frame brake according to one exemplary arrangement of the disclosure,

FIG. 2 shows a simplified schematic front view of the electromechanical frame brake according to the disclosure,

FIG. 3 shows a simplified schematic top view of the electromechanical frame brake according to the disclosure,

FIG. 4 shows a simplified schematic bottom view of the electromechanical frame brake according to the disclosure,

FIG. 5 to FIG. 8 show simplified schematic sectional views along section lines A-A, B-B, C-C and D-D, respectively of the electromechanical frame brake according to the disclosure, as indicated in FIG. 2,

FIG. 9 shows another simplified schematic illustration of the electromechanical frame brake according to the disclosure for the purpose of illustrating changing of the brake pads.

### DETAILED DESCRIPTION

The following detailed description in conjunction with the appended drawings, in which identical numbers refer to identical elements, is intended as a description of various embodiments of the disclosed subject matter and is not intended to represent the only exemplary arrangements. Any exemplary arrangement described in this disclosure is purely by way of example or illustration and should not be construed as preferred or advantageous over other arrangements.

All of the features disclosed below with respect to the exemplary arrangements and/or the accompanying figures can be combined, alone or in any subcombination, with features of the aspects of the present disclosure, including features of preferred exemplary arrangements, provided that the resulting combination of features is worthwhile for a person skilled in the art.

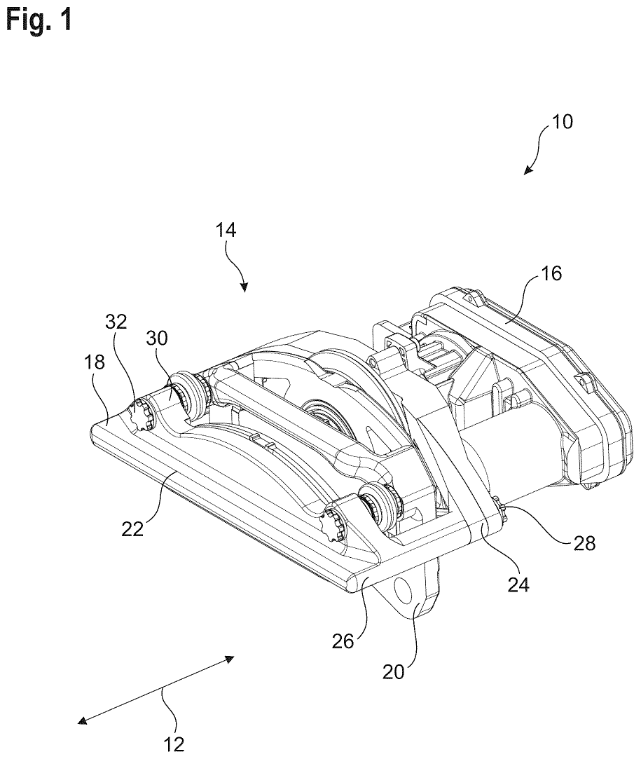

FIG. 1 shows a simplified schematic isometric illustration of an electromechanical frame brake 10 according to one exemplary arrangement of the disclosure.

Along the axial direction of extent 12, the electromechanical frame brake 10 comprises a brake actuator unit 14 and a drive unit 16. The brake actuator unit 14 comprises a support structure which is designed as a floating frame 18 and which can be moved along the axial direction of extent 12.

The electromechanical frame brake 10 has a brake carrier 20, by means of which the frame brake 10 can be mounted on a mount, e.g. a vehicle support structure.

Axially on the outside relative to the brake carrier 20, the floating frame 18 has a crossmember 22, to which an outer brake pad of the frame brake 10 is coupled at least indirectly.

In addition, the floating frame 18 has a piston-receiving housing 24 for a brake piston guided therein. Starting from the brake carrier 20, the piston-receiving housing 24 is arranged opposite the crossmember 22.

The crossmember 22 is coupled to the piston-receiving housing 24 via radially outer lateral struts 26, in which corresponding retaining screws 28 engage.

The lateral struts 26 are formed integrally with the crossmember 22. The integral formation of the lateral struts 26 with the crossmember 22 enables otherwise necessary assembly mechanisms and material transitions to be avoided. The housing rigidity of the frame brake 10 and, more specifically, of the floating frame 18 is thereby increased.

Starting from the crossmember 22, the lateral struts 26 extend beyond the brake carrier 20 along the axial direction of extent 12. This leads to an additional increase in the housing rigidity of the floating frame 18 of the frame brake 10.

An increase in the housing rigidity enables the shear forces that occur during the activation of the frame brake 10 to be compensated and dissipated better than before.

The crossmember 22 is additionally coupled to the brake carrier 20 by axial linear guides 30, which have sliding bearings 31 in which corresponding retaining screws 32 engage. The axial linear guides 30 extend along the axial direction of extent 12.

The axial linear guides 30 ensure axial mobility of the floating frame 18 relative to the brake carrier 20. Since the piston-receiving housing 24 is rigidly coupled to the crossmember 22 of the floating frame 18, the piston-receiving housing 24 is also movable relative to the brake carrier 20 by virtue of the axial linear guides 30.

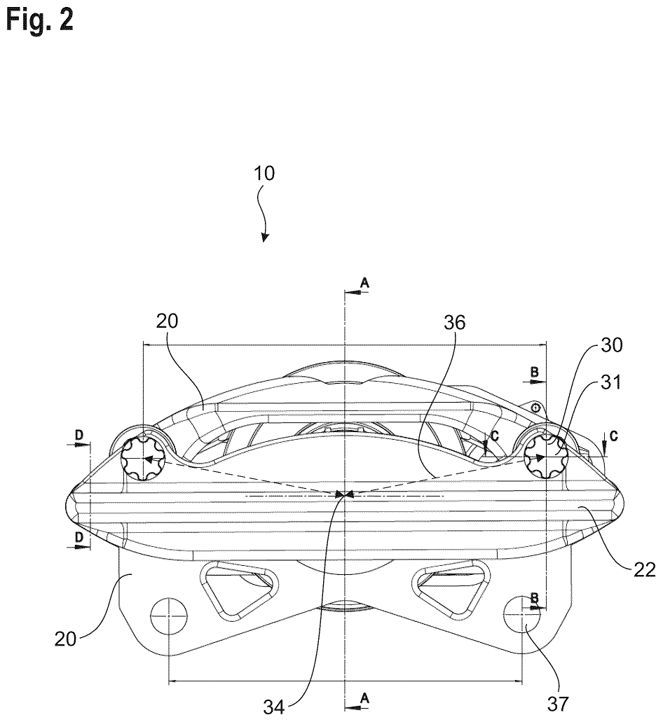

FIG. 2 shows a simplified schematic front view of the electromechanical frame brake 10 according to the disclosure.

It can be seen here that the axial linear guides 30 are at the same radial distances 36 with respect to the rotation axis 34 of the brake actuator unit 14 of the frame brake 10 (corresponding in the ideal case of compensated shear and tilting forces also to the rotation axis of the underlying brake disc rotor). In other words, the axial linear guides 30 are arranged symmetrically with respect to the rotation axis 34 of the frame brake 10. It is thereby possible to prevent the possibility of eccentric forces being caused by the axial linear guides 30.

The brake carrier 20 comprises corresponding coupling structures 37, by which the frame brake 10 can be mounted, e.g. on a vehicle support structure.

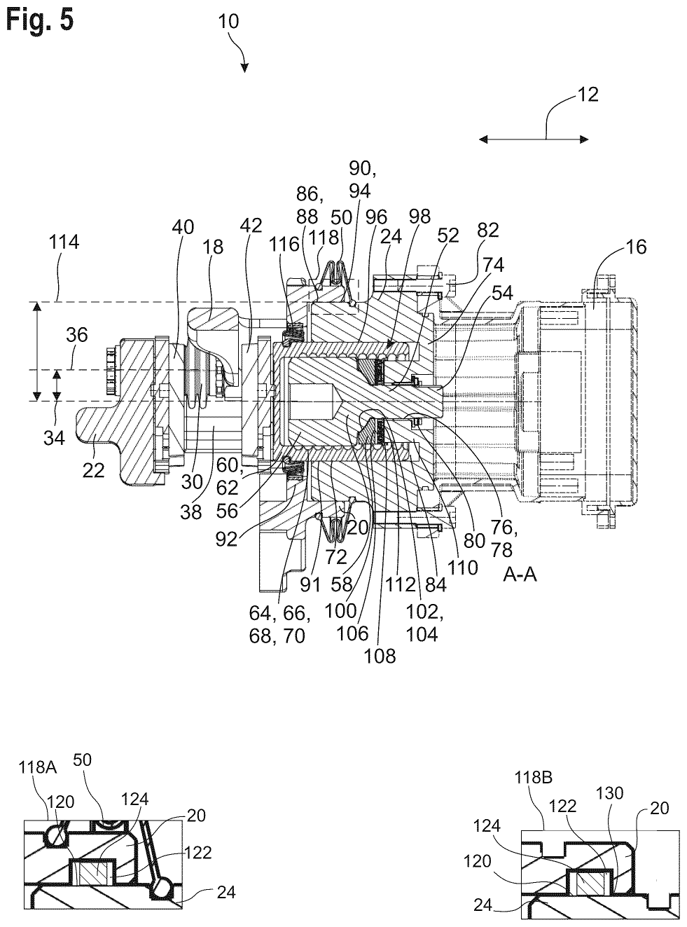

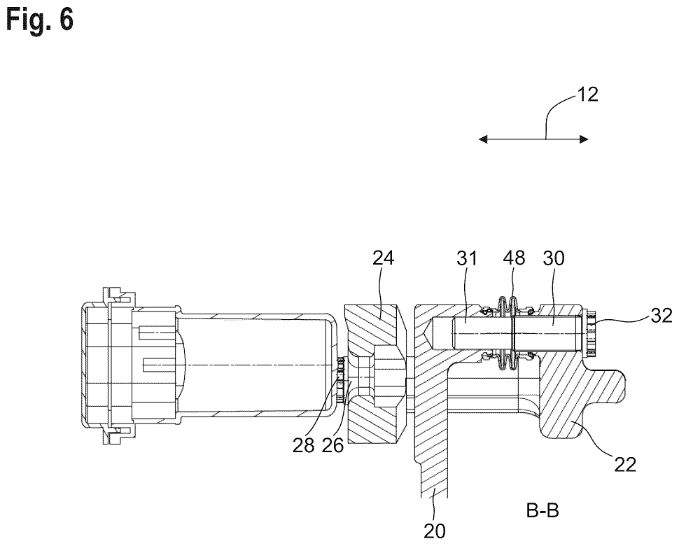

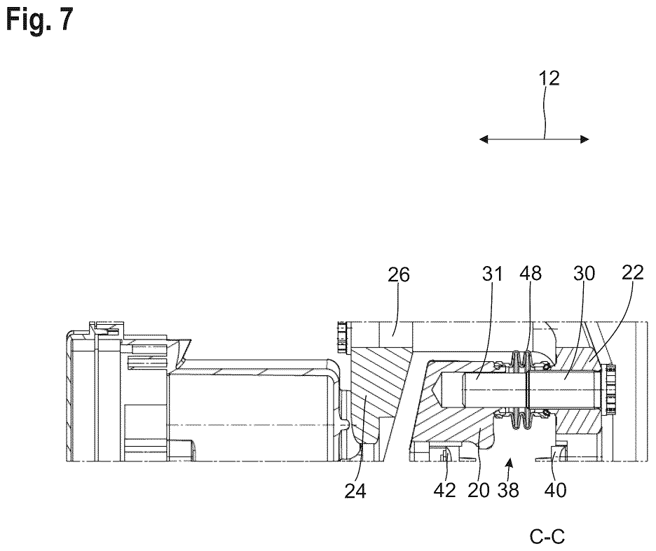

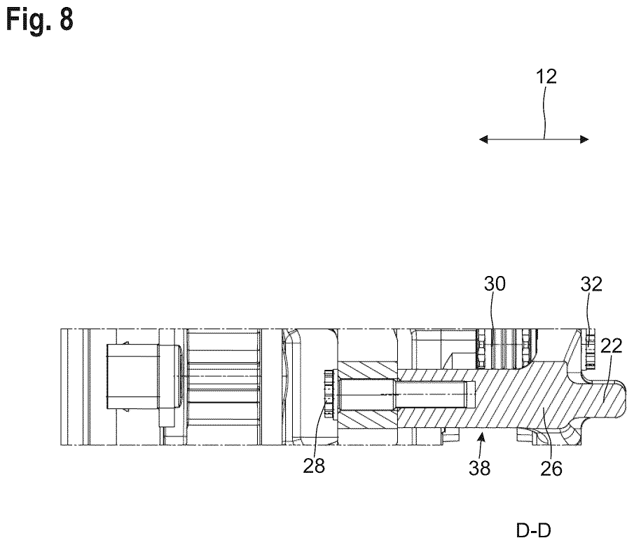

The section lines A-A, B-B, C-C and D-D of the sectional illustrations shown in FIGS. 5 to 8 are furthermore indicated in this view.

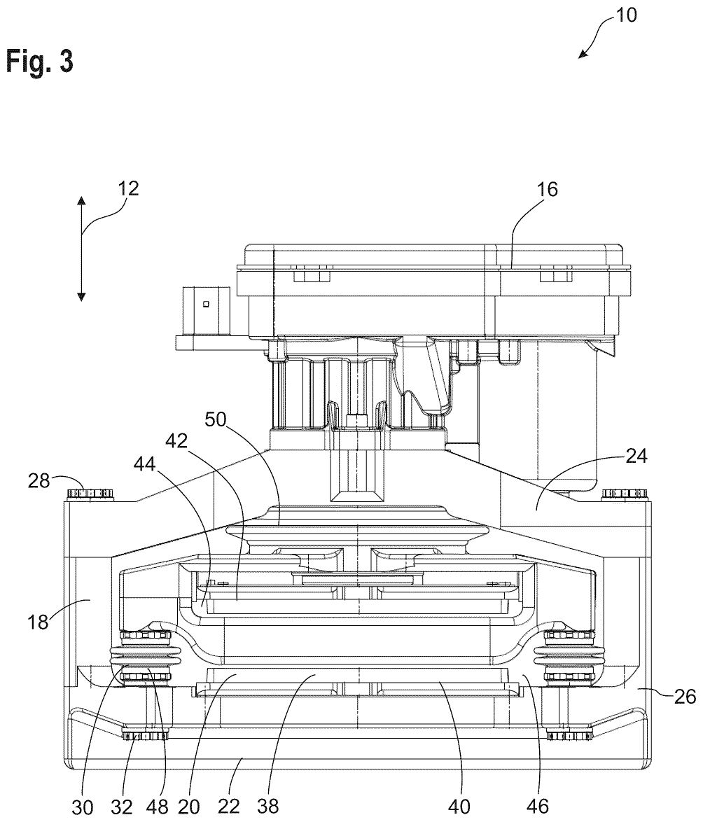

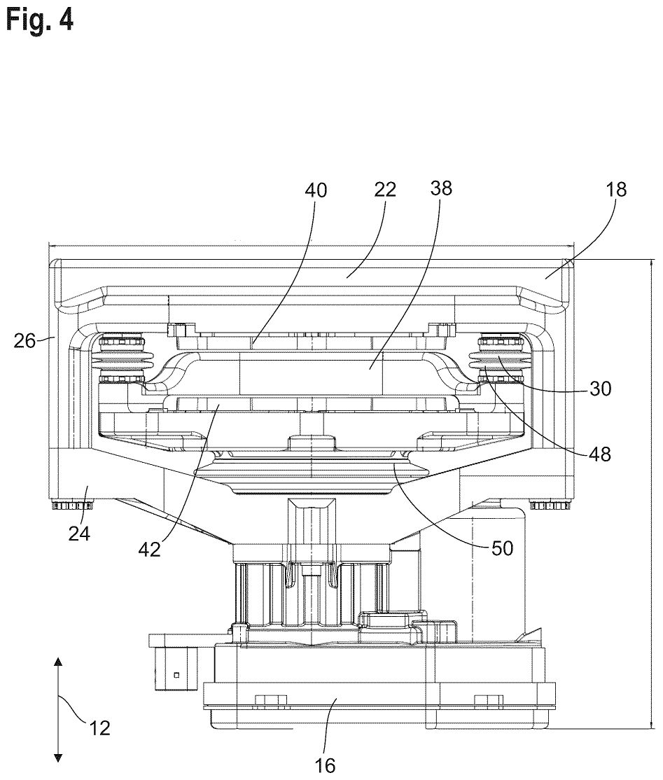

FIG. 3 shows a simplified schematic top view of the electromechanical frame brake 10 according to the disclosure, and FIG. 4 shows a simplified schematic bottom view of the electromechanical frame brake 10 according to the disclosure.

A receiving space 38 for the brake disc rotor is provided in the region of the brake carrier 20.

An outer brake pad 40 is mounted on the crossmember 22. An inner brake pad 42 is arranged in the opposite direction along the axial direction of extent 12, starting from the receiving space 38, and therefore the brake disc rotor can come into contact from opposite directions with the outer brake pad 40 and the inner brake pad 42 during operation. The brake disc rotor is therefore enclosed by the two brake pads 40, 42 along the axial direction of extent 12.

While, in general, the inner brake pad 42 can be moved actively in the direction of the brake disc rotor by the brake piston of the brake actuator unit 14, contact between the outer brake pad 40 and the brake disc rotor is ensured by the mobility of the floating frame 18 as such.

It can furthermore be seen that the brake carrier 20 forms a window 44 open radially towards the outside for the inner brake pad 42.

In addition, a further window 46 open radially towards the outside is formed between the brake carrier 20 and the crossmember 22 for the outer brake pad 40.

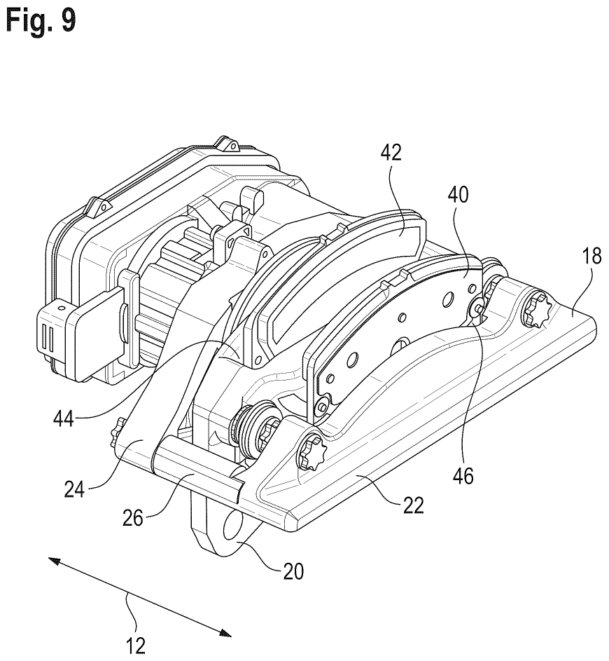

Through the windows 44, 46, the outer brake pad 40 and the inner brake pad 42 can be removed from or inserted into the frame brake 10, e.g. for assembly purposes or in the case of exchange as part of servicing work. In this context, FIG. 9 shows another simplified schematic illustration of the electromechanical frame brake 10 according to the disclosure for the purpose of illustrating changing of the brake pads 40, 42, which can be inserted through the windows 44, 46. This makes it possible to change the brake pads 40, 42 in a process that advantageously does not require removal of other parts of the frame brake 10.

In the illustrations in FIGS. 3 and 4, it can furthermore be seen that the axial linear guides 30 have axially flexible guide seals 48, by which the linear guides 30 can be protected from contaminants.

In addition, in the region of the piston-receiving housing 24, the frame brake 10 comprises an encircling bellows seal 50, which extends between the brake carrier 20 and the piston-receiving housing 24. Since the brake carrier 20 provides a guide for the piston-receiving housing 24, as explained in detail further below, this guide can be protected from contaminants by the bellows seal 50.

FIG. 5 to FIG. 8 show simplified schematic sectional views along section lines A-A, B-B, C-C and D-D of the electromechanical frame brake 10 according to the disclosure, as indicated in FIG. 2.

In the ideal case of compensated shear and tilting forces, the rotation axis 34 of the brake actuator unit 14 of the frame brake 10 also corresponds to the rotation axis of the underlying brake disc rotor and to the central axis of the overall housing of the frame brake 10 (generally defined by the brake carrier 20).

During operation, the inner brake pad 42 is actively subjected to an application force Fz in the direction of the brake disc rotor by the brake actuator unit 14.

The axially movable floating frame 18 ensures that the brake pad 40 which is on the outside in the axial direction is likewise acted upon by the application force Fz. In this case, the application force Fz is distributed substantially uniformly in terms of magnitude between the inner brake pad 42 and the outer brake pad 40. Thus, as a result of the contact pressure force provided, frictional engagement with the brake disc rotor arranged in the receiving space 38 can be ensured for both brake pads 40, 42, said engagement being used to decelerate or hold a vehicle.

The frame brake 10 furthermore has an electromechanical actuating unit which serves as a drive unit 16 and is used to produce the application force Fz together with the brake actuator unit 14. Relative to the brake actuator unit 14, the drive unit 16 is arranged opposite the brake disc rotor along the axial direction of extent 12. The drive unit 16 comprises at least one electric motor, a reduction gear assembly and a parking brake mechanism.

The components of the drive unit 16 are coupled to the piston-receiving housing 24. Thus, their weight is supported by the brake carrier 20. The housing parts of the frame brake 10 are designed in general as a skeleton-like frame made of metal or of fibre-reinforced plastic. The drive unit 16 forms a closed subassembly that can be assembled separately.

The brake actuator unit 14 comprises a spindle 52 with a drive shaft extension 54, a shank section 56 on the brake pad side and a transitional section, which has a shoulder 58. The shoulder 58 is arranged between the drive shaft extension 54 and the shank section 56 along the rotation axis 34 of the spindle 52. The diameter of the drive shaft extension 54 of the brake actuator unit 14 is smaller along the radial direction than the diameter of the shank section 56 along this direction. Accordingly, the spindle 52 tapers with respect to its diameter in the region of the transitional section.

The brake actuator unit 14 furthermore has a spindle nut 60, which in the present case is configured as a brake piston 62. In the present case, the spindle drive 64 of the brake actuator unit 14 is designed as a recirculating ball screw, which is free of self-locking. This means that the spindle drive 64 comprises a spindle thread 66, in which balls 68 are arranged and roll. The spindle 52 and the spindle nut 60 have mutually corresponding race parts, which together form the spindle thread 66. The balls 68 can permit a translational movement of the spindle nut 60 along the rotation axis 34 with respect to the spindle 52 along the ball races 70 of the spindle thread 66. For this purpose, the ball races 70 are formed at least partially in the shank section 56 of the spindle 52 and of the spindle nut 60.

The diameter of the ball races 70 corresponds to the diameter of the balls 68, taking into account manufacturing tolerances and required gap dimensions.

Here, the rotation of the spindle 52 is ensured by the electric motor of the drive unit 16, which is in engagement with the drive shaft extension 54 of the spindle 52 via the reduction gear assembly. The gradients of the spindle drive 64, for example of the ball races 70, then have the effect that the rotation of the spindle 52 brings about a translational movement of the spindle nut 60. The spindle nut 60 designed as brake piston 62 imparts this movement to the brake pads 40, 42. The generated application force Fz is proportional to the torque which is produced at the drive shaft extension 54 by the drive unit 16.

The inner brake pad 42 is actively subjected to the application force Fz thus generated, emanating from the brake piston 62.

The brake actuator unit 14 further comprises the piston-receiving housing 24, which has a radially interior inner side 72 and a base 74. The open end of the piston-receiving housing 24 is arranged on the brake pad side along the rotation axis 34. This means that the base 74 is arranged at the opposite end of the piston-receiving housing 24 from the brake disc rotor. The base 74 has a through-hole 76 for the drive shaft extension 54 of the spindle 52, which is held therein by a radial bearing 78 (sliding bearing).

The axial mobility of the spindle 52 relative to the piston-receiving housing 24 is prevented by a fastening arrangement, such as, for example, a snap ring 80. The snap ring 80 is arranged on the opposite side of the base 74 of the piston-receiving housing 24 from the shank section 56 of the spindle 52.

The piston-receiving housing 24 is coupled in such a way to the drive unit 16, by a positive connection 82, that the reduction gear assembly is centred with respect to the piston-receiving housing 24. The positive connection 82 can comprise, for example, a shaft-hub connection with spline toothing or a slot-and-key connection.

The radially interior inner side 72 and the base 74 define an interior space 84 of the piston-receiving housing 24, in which at least the spindle 52 and the spindle nut 60 or the brake piston 62 are at least partially arranged. Owing to the linear mobility of the brake piston 62 designed as a spindle nut 60, this component may also be arranged at least partially outside the interior space 84.

The piston-receiving housing 24 makes it possible to design the brake actuator unit 14 as a separate subassembly.

The brake carrier 20 comprises a socket 86 with a cylindrical guide surface 88. The design of the cylindrical guide surface 88 of the brake carrier 20 corresponds to a radially exterior housing lateral surface 90 of the piston-receiving housing 24. The cylindrical guide surface 88 of the brake carrier 20 is furthermore formed concentrically with a piston lateral surface 91 of the brake piston 62 designed as a spindle nut 60. The centres of the cylindrical guide surface 88 and of the piston lateral surface 91 of the brake piston 62 coincide with the rotation axis 34 in the ideal case of compensated transverse forces.

The cylindrical guide surface 88 of the brake carrier 20 is delimited by a base section 92 of the brake carrier 20. The cylindrical guide surface 88 and the base section 92 define the socket 86 in which the piston-receiving housing 24 is mounted in a manner that allows axial movement. In this case, the bellows seal 50 extends circumferentially between the brake carrier 20 and the piston-receiving housing 24 and delimits the socket 86 in the opposite direction to the base section 92 of the brake carrier 20 along the axial direction of extent 12.

A rotational securing arrangement 94, by which rotation of the piston-receiving housing 24 relative to the brake carrier 20 is prevented, is formed between the brake carrier 20 and the piston-receiving housing 24.

In addition, a rotary lock 96, by which rotation of the spindle nut 60 relative to the piston-receiving housing 24 is prevented, is formed between the piston-receiving housing 24 and the spindle nut 60.

The piston-receiving housing 24, with the spindle drive 64 accommodated therein, the spindle nut 60 designed as a brake piston 62, and the spindle 52, is thus supported radially and axially as a subassembly in the socket 86 of the brake carrier 20, with axial mobility being ensured. Relative rotation is allowed only for the spindle 52 and the balls 68 of the spindle drive 64 and, otherwise, is prevented for the other components.

As a result of the generated application force Fz, a reaction force Fr, which is opposite to the application force Fz, occurs along the rotation axis 34. Owing to the elastic expansion of the components of the frame brake 10, an angular misalignment can generally occur between the rotation axis of the brake disc rotor and the cylinder axis of the frame brake 10, with the result that the reaction force Fr has off-centre force components. These off-centre force components can lead to instability of the components of the brake actuator unit 14 along the radial direction, particularly if the core diameter of the spindle drive 64 is smaller than the outside diameter of a bearing which is intended to absorb the reaction force Fr.

In the present case, therefore, the brake actuator unit 14 comprises a rotationally symmetrical axial spindle bearing 98 embodied as an axial bearing with a bearing ring 100 which has a spherical bearing contact surface 102 arranged on the brake pad side. The axial spindle bearing 98 is in contact with the shoulder 58 of the spindle 52, which has a convex section 104 forming a ring on a spherical surface. The spherical bearing contact surface 102 is concavely shaped and is of complementary design to the section 104.

The bearing ring 100 furthermore has a planar contact surface 106, which is arranged opposite the spherical bearing contact surface 102 along the rotation axis 34.

Furthermore, the brake actuator unit 14 has rolling elements 108, which are in contact with the planar contact surface 106.

The piston-receiving housing 24 comprises a high plateau 110 extending axially from the base 74 in the direction of the brake disc rotor.

Arranged between the axial spindle bearing 98 and the base 74 of the piston-receiving housing 24 there is, in addition, a bearing disc 112, which has opposite planar contact surfaces along the rotation axis 34 and is pressed into the piston-receiving housing 24 in a rotationally secure manner by frictional and/or positive engagement. One of the contact surfaces of the bearing disc 112 is in contact with the high plateau 110 of the piston-receiving housing 24. The rolling elements 108 roll on the other of the two contact surfaces of the bearing disc 112. The high plateau 110 shortens the axially required length of the piston-receiving housing 24, thereby making it possible to save installation space along the axial direction of extent 12.

Thus, the reaction force Fr which occurs is transmitted from the shank section 56 of the spindle 52, via the shoulder 58, to the spherical bearing contact surface 102 of the axial spindle bearing 98, and from there is absorbed by the base 74 of the piston-receiving housing 24 via the rolling elements 108 and the bearing disc 112.

Via the lateral struts 26, the reaction force Fr is transmitted to the crossmember 22, thus enabling the outer brake pad 40 to be moved in the direction of the brake carrier 20 in order to ensure contact between the outer brake pad 40 and the brake disc rotor.

The mobility of the crossmember 22 relative to the brake carrier 20 is ensured by the axial linear guides 30. Since, with respect to the cylindrical guide surface 88, these are at equal distances 36 from the centre 114 of the guide surface 88, which coincides with the rotation axis 34, these guide mechanisms act together (in a quasi-unitary manner). It is thus possible to provide better compensation than hitherto of shear forces that occur when the frame brake 10 is activated since previous frame brakes do not have the additional guide mechanism of the socket 86.

Since the socket is provided by the brake carrier 20 itself, it is also arranged close to the centre of gravity of the frame brake 10. In this case, the guide mechanisms are advantageously arranged on both sides of the centre of gravity of the frame brake. The guide mechanism ensured by the axial linear guides 30 is arranged axially on the outside relative to the brake carrier. In contrast, the guide mechanism of the socket 86 of the brake carrier is arranged axially on the inside. It is thereby possible to provide better compensation of tilting forces that may occur on account of the mass distribution of the components of the frame brake 10 along the axial direction of extent 12. As a consequence, the housing rigidity of the frame brake 10 is increased. This ensures the advantages explained above in respect of service life, constancy of the desired brake application path and reduction of the fuel consumption of a vehicle that has the frame brake 10.

In order to protect the spindle drive 64, an axially extending seal 116 extends between the spindle nut 60 and the brake carrier 20.

At the bottom left and bottom right, FIG. 5 shows two exemplary arrangements 118A and 118B of the socket 86 of the brake carrier 20. The position of the embodiments 118A, 118B is indicated in the main image in FIG. 5.

In general, the socket 86 of the brake carrier 20 has the cylindrical guide surface 88, in which the housing lateral surface 90 of the piston-receiving housing 24 is mounted in a manner that allows axial movement. In exemplary arrangement 118A, it can be seen that a gap 120 is formed between the guide surface 88 and the housing lateral surface 90. The brake carrier 20 comprises a groove 122, which is radially on the outside in relation to the housing lateral surface 90 of the piston-receiving housing and in which a return element 124 is arranged.

In the present case, the return element 124 is formed from an elastically deformable elastomer and shaped as an annular body. However, it is also conceivable for the return element 124 to be designed as a metal spring. Here, therefore, the return element 124 surrounds the housing lateral surface 90 of the piston-receiving housing 24.

Due to the return element 124, the axially movable piston-receiving housing 24 can be pushed back into an initial position, i.e. towards the brake disc rotor along the axial direction, in the case where no force is being applied. Since the outer brake pad 40 is coupled directly to the piston-receiving housing 24 via the crossmember 22, the outer brake pad 40—on the far side of the brake disc rotor—is then moved away from said rotor, resulting in an increase in the distance between the outer brake pad 40 and the brake disc rotor. Consequently, it is possible by operation of the return element 124 to ensure a defined initial position of the outer brake pad 40, which is freed by the return element 124.

In addition, the return element 124 also ensures the centring of the piston-receiving housing 24.

In exemplary arrangement 118B, the bellows seal 50 is omitted. In this case, the return element 124 also ensures a sealing functionality that is ensured by the bellows seal 50 in exemplary arrangement 118A. This means that it is possible, for the socket 86 to be protected by the return element 124 from contaminants in respect of the guidance of the housing lateral surface 90 of the piston-receiving housing 24 within the guide surface 88 of the brake carrier 20. In addition, the spindle drive 64 is then also protected from contaminants.

In both exemplary arrangements 118A and 118B, the plunge-cut edge of the groove 122 that is further away from the brake disc rotor (during the production of the groove, two plunge-cut edges are formed by the penetration of a lathe tool or plunge-cut lathe tool) can be provided in each case with a chamfer 130, by which the rollback effect, i.e. the storage and release of the deformation energy of the elastic annular body, for example when using an elastomer, and thus the return of the piston-receiving housing is assisted.

1. An electromechanical frame brake comprising: a floating frame assembled from a plurality of parts, a brake piston, which can be moved axially by a spindle drive and is seated on a spindle of the spindle drive and is guided in a piston-receiving housing, wherein the floating frame has the piston-receiving housing, lateral struts, and an outer crossmember, which is connected via the lateral struts to the piston-receiving housing and carries an outer brake pad, wherein the floating frame is mounted by way of axial linear guides in such a way as to float relative to a brake carrier of the frame brake and to be axially movable relative to the brake carrier, and the brake carrier has a socket with a guide surface for the piston-receiving housing, which is mounted in an axially movable manner in said socket.

2. The electromechanical frame brake according to claim 1, wherein in, at least in some region or regions, the guide surface is formed concentrically with a piston lateral surface of the brake piston, and/or in that the guide surface is of cylindrical design.

3. The electromechanical frame brake according to claim 1, wherein the axial linear guides are sliding bearings on the brake carrier.

4. The electromechanical frame brake according to claim 3, wherein the sliding bearings are at equal radial distances from a centre of the guide surface.

5. The electromechanical frame brake according to claim 1, wherein the floating frame surrounds the brake carrier in a top view of the frame brake.

6. An electromechanical frame brake according to claim 1, wherein the struts merge integrally into the crossmember.

7. An electromechanical frame brake according to claim 6, wherein the piston-receiving housing is screwed to the struts at the end face.

8. An electromechanical frame brake according to claim 1, wherein the brake carrier has a window which is open radially towards the outside and through which an inner brake pad can be installed and removed without removing the floating frame, and/or a window which is open radially towards the outside and through which the outer brake pad can be installed and removed without removing the floating frame is provided between the brake carrier and the crossmember.

9. The electromechanical frame brake according to claim 1, wherein the piston-receiving housing has a base, on which the spindle is supported during the actuation of the frame brake.

10. The electromechanical frame brake according to claim 9, wherein an axial spindle bearing having a bearing contact surface is arranged between the base of the piston-receiving housing and the spindle.

11. The electromechanical frame brake according to claim 10, wherein the spindle merges at its drive-side end, via an encircling shoulder, into a drive shaft extension of reduced cross section, wherein the shoulder has a convex section which forms a ring on a spherical surface, and the axial spindle bearing has a complementary contact section with the bearing contact surface to allow a tilting movement of the spindle relative to the piston-receiving housing.

12. The electromechanical frame brake according to claim 1, wherein the brake piston is shaped as a spindle nut by a formation of a spindle thread on an inner side.

13. The electromechanical frame brake according to claim 1, wherein an axially extending seal is provided radially between the brake piston and the brake carrier.

14. The electromechanical frame brake according to claim 1, wherein an encircling bellows seal is arranged radially on an outside between the brake carrier and the piston-receiving housing.

15. The electromechanical frame brake according to claim 1, wherein the brake carrier, has a return element, which is configured to return the piston-receiving housing to an initial position in a state of the frame brake in which the frame brake is not subject to any force.

16. The electromechanical frame brake according to claim 15, wherein the socket of the brake carrier has a groove in which the return element is arranged.

17. The electromechanical frame brake according to claim 15, wherein the return element has an annular body, wherein the return element is arranged radially on the outside of a housing lateral surface of the piston-receiving housing.

18. The electromechanical frame brake according to claim 15, wherein the return element comprises an elastic material.
